(19) United States
(12) Patent Application Publication
(10) Pub. No.: US 2008/0041517 A1
(43) Pub. Date: Feb. 21, 2008

(54) Assembling Two Substrates by Molecular Adhesion, One of the Two Supporting an Electrically Conductive Film

(75) Inventors: Hubert Moriceau, Saint Egreve (FR); Guy Feuillet, St Martin D'Uriage (FR); Stephane Pocas, Grenoble (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Commissariat A L'Energie Atomique, Paris (FR)

(21) Appl. No.: 11/630,033

(22) PCT Filed: Jun. 29, 2005
(86) PCT No.: PCT/FR05/50521

§ 371 Date: Dec. 19, 2006

(30) Foreign Application Priority Data
Jun. 30, 2004 (FR) 0451376

(51) Int. Cl. B29C 65/02; B29C 65/14

(52) U.S. Cl. 156/182; 156/272.2; 156/272.6; 156/60

(57) ABSTRACT

A process assembling first and second substrates on contact faces by molecular bonding. The first substrate contact face has an electrically conducting layer on at least part of its surface. The process deposits a bond layer on at least part of the electrically conducting layer, which bond layer can molecularly bond with a zone of the second substrate contact face and be combined with the electrically conducting layer to form a conducting alloy, contacts the bond layer with the zone of the second substrate contact face and molecularly bond them, and transforms over all or part of its thickness of all or part of the electrically conducting layer with all or part of the bond layer and with at least part of the thickness of the zone of the contact face on all or part of the surface of the second substrate to form a conducting alloy(s) zone.

### TECHNICAL DOMAIN

The invention relates to a process for assembly of two substrates by molecular bonding, at least one of the two substrates supporting an electrical conducting film.

### STATE OF PRIOR ART

In the microelectronic field, it is often necessary to assemble two substrates on the two main faces of these substrates. For example, the objective may be to transfer a thin layer delimited in an electronic quality semiconducting substrate onto another substrate acting as a support. One appreciated technique for making such an assembly is molecular bonding, that prevents the use of an adhesive substance. This technique is particularly effective to fix two semiconducting substrates of the same nature, for example two silicon substrates. In this case, this effectiveness can be further improved if the faces to be put into contact are covered by an oxide. However, the faces to be put into contact may have metallic zones.

Many documents according to prior art disclose processes for assembling substrates using metallic films.

For example, in document [1], the authors B. Aspar and al. explain that two silicon substrates can be assembled using films of palladium at ambient temperature.

In document [2], the authors Thüngstrom and al. disclose a process for siliciding cobalt after bonding two Co metallic films deposited on two substrates of N and/or P doped silicon.

Finally, in document [3], the authors Shigetou and al. disclose how to make local metallic copper bonding using a technique to obtain electrodes with well controlled profiles.

The authors of these different documents are all interested in obtaining electrical conduction at the bond between the two substrates. However, they do not present processes for obtaining good bonding over the entire surface of the substrates to be assembled. Good bonding means bonding with no defect such as bubbles or trapped particles between the two substrates, and having a high bonding energy at low temperatures.

Furthermore, conduction obtained in these documents at the bonding interface is at a <<macroscopic>> scale and cannot be controlled on every zone of the surface. It appears as an averaged value over the bonding surface considered. But this dispersion of the vertical conduction results at the interface between two substrates may be a problem, particularly if it is required to obtain a structure with small vertical conduction surfaces.

Structures according to prior art obtained by the assembly of two substrates by molecular bonding using a metallic film have a poor quality bond and/or the bond is not sufficiently strong and/or they comprise metal oxide that reduces conduction at the bonding zone.

Document [4] also discloses a process for obtaining a buried layer of cobalt silicide under a thin film of silicon. The buried layer of cobalt silicide is obtained by assembling a silicon substrate, comprising a thin layer of cobalt and a thin layer of silicon, with an implanted silicon substrate, and then applying a heat treatment to the assembly. The cobalt layer then reacts with the thin silicon layer by forming cobalt silicide. The disadvantage of this process is that it cannot improve conduction at the bonding interface between the two substrates.

### PRESENTATION OF THE INVENTION

The purpose of the invention is to provide a process for assembly of two substrates, at least one of which supports an electrically conducting layer, for example formed from one or several films made of a metal or a conducting alloy such as a metal silicide or a metal germanicide, said process not having the disadvantages of prior art and in particular being capable of improving conduction at the bonding interface.

This purpose is achieved by a process for assembly of a first substrate and a second substrate on contact faces by molecular bonding, the contact face of the first substrate having an electrically conducting layer on at least part of its surface, the process including the following steps:

deposition of a bond layer on at least part of the electrically conducting layer, said bond layer being capable of achieving molecular bonding with a zone of the contact face of the second substrate and capable of combining with the electrically conducting layer to form a conducting alloy,

contact the bond layer of the first substrate with the zone of the contact face of the second substrate and bond them by molecular bonding,

transformation over all or part of its thickness, of all or part of the electrically conducting layer with all or part of the bond layer and with at least part of the thickness of the zone of the contact face on all or part of the surface of the second substrate to form a zone of conducting alloy(s).

Therefore the electrically conducting layer is capable of combining with the bond layer and with the zone of the contact face of the second substrate to form one or several conducting alloys forming a zone of conducting alloy(s) extending on each side of the bonding interface. The invention thus makes the zone around the bonding interface conducting. A <<bonding interface>> means the contact zone between contact faces of the substrates (with or without the bond layers), when the substrates are assembled by molecular bonding.

The expression <<all or part>> should be understood in the plane of the layers in contact, namely in the plane of the layer of electrically conducting material and in the plane of the bond layer, and not on the thickness of these layers. According to the invention, the entire thickness of the bond layers is transformed into an alloy material (the electrically conducting layer is not necessarily entirely consumed). But if for example the layer of the electrically conducting material is located only on part of the bond layer, then the alloy will only form on a local <<part>> of the bond layer (for example see FIGS. 5B and 6B commented below).

Note that in talking about the face or surface, this face is not necessarily made of the same material, but it may be made of several different materials.

Advantageously, the transformation step consists of a heat treatment. The heat treatment temperature and time are chosen as a function of the required alloy(s) and the quantity of alloy to be obtained. In particular, the heat treatment time may be adapted to facilitate the interaction between the electrically conducting layer deposited on a first substrate and a surface part of the second substrate. The affinity between the material in the bond layer and the material in the electrically conducting layer to form an alloy determines the temperature to which the structure must be raised so that the alloy can be formed. Either combined or alternately, this transformation step may include a pressurisation step or an electro-migration step known to those skilled in the art to form an alloy.

The substrates may be made of any material. They may or may not include processed levels. It may also be a set of tracks in an insulator. The first substrate may be a CMOS or a CCD read circuit, etc., with bonding pads on its surface. This circuit may have a topology on its surface. The second substrate may for example be made of a photodetecting or photoemitting material or a multilayer structure (diode . . . ).

According to a first embodiment, the assembly process further comprises, before the contacting and bonding step, a step for formation of the zone of the contact face of the second substrate by deposition of a bond layer that can achieve molecular bonding with the bond layer of the first substrate and can react with the electrically conducting layer deposited on the first substrate to form a conducting alloy. Therefore the contacting and molecular bonding step is made between the bond layer of the first substrate and the bond layer included on the contact face of the second substrate.

Advantageously, the bond layer of the first substrate and the bond layer of the second substrate are made of the same material. The result is a uniform alloy zone in terms of its composition.

According to a second embodiment, the assembly process further comprises, before the contacting and bonding step, a step for formation of the zone of the contact face of the second substrate by deposition of an electrically conducting layer covered at least partly by a bond layer capable of achieving molecular bonding with the bond layer of the first substrate and capable of combining during the transformation step with said electrically conducting layer of the second substrate to form a conducting alloy. In this case, the contact face of the second substrate comprises a bond layer over an electrically conducting layer; therefore the contacting and molecular bonding step is done between the bond layer of the first substrate and the bond layer formed on the contact face of the second substrate. It is thus possible to make a structure resulting from the assembly of two substrates each comprising an electrically conducting layer on which a layer of determined material acting as a bond layer is formed.

Advantageously, the thickness of the bond layer of the first and/or the second substrate and the thickness of the layer of electrically conducting material in the first and/or second substrate, and the duration of the heat treatment (annealing time) are adapted such that the conducting alloys created are located at and/or around the substrate bonding interface.

Advantageously, the electrically conducting layer located on the zone of the contact face of the second substrate is also capable of combining with said material in the bond layer located on the first substrate, during the transformation step, to form a conducting alloy included in the alloy zone.

Advantageously, the bond layer of the first substrate and the bond layer of the second substrate are made of the same material and the electrically conducting layer of the first substrate and the electrically conducting layer of the second substrate are made of the same material.

Advantageously, the electrically conducting layer of the first substrate and/or of the second substrate is formed from a stack of one or several films made of metal or conducting alloy. The metals include nickel Ni, platinum Pt, palladium Pd, cobalt Co, tungsten W, tantalum Ta, titanium Ti, vanadium V, chromium Cr, manganese Mn, iron Fe, molybdenum Mo or a mix of these elements. Conducting alloys include silicides or germanicides of these metals and in general, any electrically conducting material that can form conducting alloys with the materials of the bond layers and with the material of the second substrate.

Advantageously, the bond layer of the first substrate and/or the second substrate is made of a material chosen from among silicon, germanium, silicon carbide or a mix of these elements such as SiGe. The bond layer may also be a stack of several layers made of one or several of these materials. In general, the bond layer is a material that can form one or several conducting alloys with the material(s) of the electrically conducting layer.

In order to achieve good molecular bonding, the materials in the bond layer of the first substrate and/or the second substrate are advantageously chosen from among the possible materials for those skilled in the art to prepare and control their surface condition using conventional microelectronic techniques.

According to one particular embodiment, the process also comprises, before the step to deposit the bond layer of the first and/or the second substrate, a step consisting of surface treatment of the electrically conducting layer of the first and/or the second substrate, that will remove at least part of the oxides and/or insulators present on its surface. Thus, the bond layer is deposited on an electrically conducting layer on which at least part of any oxide and/or insulator is removed from its surface. This avoids the presence of any oxide and/or insulator at the interface between the electrically conducting layer and the bond layer. For example, this treatment could be done using conventional etching techniques used in microelectronics, for example by sputtering, for example ionic sputtering, and/or by chemical etching and/or by a heat treatment under a vacuum in a reducing atmosphere, these techniques possibly being used alone or in combination.

Advantageously, the process also comprises, before the contacting and bonding step of the contact faces of the two substrates, a step for surface treatment of the surface of the first substrate bond layer and the zone of the contact face of the second substrate.

Advantageously, said surface treatment step consists of chemical preparation.

Advantageously, the purpose of this treatment is to eliminate all particulate contamination on the contact surface of substrates.

Advantageously, said surface treatment step consists of a treatment leading to an entirely or partly hydrophobic surface. Such a preparation can reduce or even eliminate the oxide present on the surface during bonding, which improves vertical conduction between the assembled substrates.

Advantageously, said surface treatment step consists of a treatment leading to an entirely or partly hydrophilic surface. It is advantageous if this treatment is applied to the two contact surfaces of the substrates so that bonding by hydrogen bonds related to the presence of water on the surface, can be achieved for example at low temperatures.

Advantageously, said surface treatment step consists of a plasma treatment of at least one of the contact surfaces so as to obtain a high bonding energy at low temperature.

Advantageously, said surface treatment step consists of a UV and/or ozone treatment, or a heat treatment or a treatment in a controlled atmosphere. All these techniques may be used in combination, provided that they are compatible.

### BRIEF DESCRIPTION OF THE DRAWINGS

The invention will be better understood and other advantages and special features will appear after reading the following description given as a non-limitative example accompanied by the appended drawings among which:

FIGS. 1A and 1B show steps in an example embodiment of the assembly process according to the invention,

FIG. 2 shows a step in another example embodiment of the assembly process according to the invention,

FIGS. 3A and 3B show steps in another example embodiment of the assembly process according to the invention,

FIGS. 4A and 4B show steps in another example embodiment of the assembly process according to the invention,

FIGS. 5A and 5B show steps in another example embodiment of the assembly process according to the invention,

FIGS. 6A and 6B, 7A and 7B show steps in other example embodiments of the assembly process according to the invention,

FIGS. 8A to 8I show the steps in another example embodiment of the assembly process according to the invention.

Note that the dimensions of the layers and substrates in these figures are not shown to scale.

### DETAILED PRESENTATION OF PARTICULAR EMBODIMENTS

We will now describe the method of making several structures using the process according to the invention.

We will start by making a structure resulting from the assembly of one silicon substrate with another silicon substrate comprising a layer of metal in nickel. We will begin by depositing a nickel layer 3 on a silicon substrate 1. The nickel layer may be deposited using a conventional deposition technique known to those skilled in the art, for example by sputtering. The thickness of the deposited layer 3 is a few nanometers to a few micrometers. The next step is to deposit a bond layer 4 on the Ni layer 3; this bond layer 4 may be made of amorphous silicon. The thickness of the amorphous silicon layer 4 may for example be of the order of magnitude of half the thickness of the Ni layer 3 previously deposited. To avoid the presence of any oxide at the interface between the Ni layer 3 and the amorphous Si layer 4, prior etching is preferably done on the surface of the Ni layer. For example, this etching may be done by sputtering, for example ionic sputtering. It is preferable if this sputtering is done under a vacuum in the frame used for the deposition of the amorphous Si to prevent the exposure to air or to oxygen between these two steps.

The assembly composed of the silicon substrate 1, the nickel layer 3 and the amorphous silicon layer 4 is then chemically cleaned so as to eliminate any particulate contamination, particularly at the contact surface for bonding with another substrate 2. For example, this assembly can be dipped into a solution of (NH₄OH:H₂O₂:H₂O). The surfaces to be assembled are thus made hydrophilic.

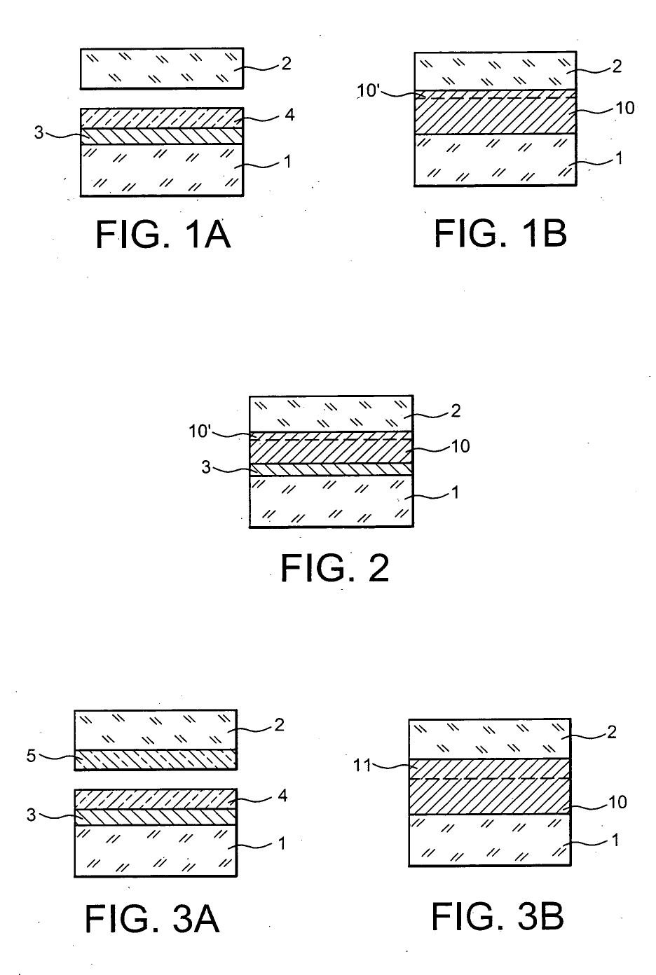

The amorphous silicon layer of this assembly is put into contact and molecular bonded onto the surface of a second substrate 2, for example a silicon substrate (see FIG. 1A). Molecular bonding is an assembly technique well known to those skilled in the art. This bonding may be done at ambient temperature or at a higher temperature, and it may or may not be assisted by the application of a partial vacuum or a pressure on the assembly.

Finally, the structure thus made is heat treated so as to make all (see FIG. 1B) or part (see FIG. 2) of the nickel layer 3 (metallic layer) react with the amorphous silicon layer 4 (bond layer), and part of the thickness of the second substrate 2. The result obtained is an alloy zone formed from an alloy 10 originating from the reaction of the bond layer 4 with the metallic nickel layer 3 and an alloy 10′ originating from the reaction of a superficial part of the second substrate 2 with the metallic nickel layer 3. Remember that the layers are not shown to scale in the figures. In FIG. 1B, the layer 3 is entirely consumed. In FIG. 2, it is only partially consumed in thickness. In this case, since the bond layer 4 and the second substrate 2 are made of silicon, the result is a single silicide alloy. Note that in FIG. 1B, and in FIGS. 3B, 4B, 5B, 6B, 7B and 8H, the diffusion of the conducting material 3 in the substrate 1 is not shown; for example it is considered that the substrate 1 comprises a barrier layer to diffusion of the conducting material (not shown) on the surface and subjacent to the conducting material. The heat treatment temperature and time are chosen as a function of the required silicide phase and the quantity of silicidisation to be induced. The heat treatment can be stopped before the entire thickness of the metallic layer is transformed into an alloy. For example, the heat treatment to obtain an alloy of NiSi silicide phase will be done at a temperature of more than 350° C., for example 450° C. The heat treatment duration may be between 1 minute and 10 hours to enable formation of a thickness of between a few nanometers to a few micrometers of NiSi for an amorphous silicon layer of between a few nanometers to a few micrometers thick. If palladium Pd is used instead of Nickel, about 15 minutes at a temperature of approximately 275° C. will generate about 142 nanometers of Pd₂Si from a layer consisting of 100 nanometers of Pd and 68 nanometers of Si. For these evaluations, it is also important to take account to the fact that the thickness of silicide obtained depends on the nature of the materials considered forming the alloy.

There is no need to have the same material on both sides of this bonding interface so that the alloy zone will eventually encompass the bonding interface. The material used in the bond layer 4 supported by the first substrate and the material in the bond layer 5 supported by the second substrate or the material in the second substrate itself are chosen as a function of the material in the layer of conducting material 3 in the first substrate.

We will give a few examples in which the abbreviation M1 relates to the layer of conducting material 3 in the first substrate, the abbreviation L1 relates to the bond layer 4 in the first substrate and the abbreviation L2 relates to a superficial part of the second substrate or its bond layer 5 when it contains one.

For example, for M1 made of a material chosen from among Ni, Co, Pt, Pd, Ti . . . , L1 and L2 can be chosen to be silicon.

For example, if M1 is chosen to be nickel or cobalt, L1 may be silicon and L2 may be germanium; the thermal transformation will be done at a compatible temperature to obtain a silicide and a germanicide; for example, in the case of a layer M1 made of nickel, the temperature will advantageously be chosen to be more than 350° C. and for example 400° C.

The thickness of the layer of conducting material 3 (M1) must be sufficient, so as to be sure that the transformation reaction into an alloy (for example a siliciding reaction) also takes place beyond the bonding interface. The choice of the thickness of the layer (M1) is made taking account of:

the transformation reaction to be induced firstly between the layer (M1) and the bond layer (L1), and secondly between the layer (M1) and the bond layer (L2) or the second substrate 2,

the thickness of the bond layer (L1),

the nature of the first substrate 1 on which this layer (M1) is deposited, if this layer M1 is capable of reacting with the first substrate 1,

the nature of the support (L2), either the second substrate 2 or the bond layer 5 deposited on this second substrate,

the thickness of the layer L2 to be made to react,

whether or not there is a metallic layer on the second substrate 2, that itself participates in formation of the alloy zone.

For a silicidation reaction, the ratios of the consumed thickness of Si as a function of the thickness of the consumed metal are given in table 1 below for different silicides formed.

TABLE 1

| | Silicide formed | | | | | | | |
|---|---|---|---|---|---|---|---|---|
| | Ni₂Si | NiSi | NiSi₂ | Pd₂Si | PdSi | Co₂Si | CoSi | CoSi₂ |
| Ratio | 0.91 | 1.83 | 3.65 | 0.68 | 1.36 | 0.91 | 1.82 | 3.64 |

A layer of nickel 3 (M1) is deposited on a first silicon substrate 1 with a thickness of X nm, followed by an 18.3 nm thick bond layer 4 (L1) made of silicon. This stack is assembled by molecular bonding on a second substrate 2 supporting a 100 nm silicon bond layer (for example see FIGS. 1A, 1B and 2).

Since the nature of the bond layer 4 (L1) is the same as the first substrate 1, it may be considered that the reaction will take place <<above>> and <<below>> the layer of conducting material 3 (M1).

It is decided that it is required to obtain an NiSi alloy. In this case, the quantity of silicon consumed in the first substrate 1 will be about the same as in the bond layer 4 (L1) and in the upper part of the second substrate (L2). For example, it is assumed that a surface thickness of 9.15 nm will be transformed into alloy in the second substrate. Therefore the consumption of silicon <<above>> is (18.3+9.15) nm. A total consumption of silicon (S1+L1+L2) equal to (18.3 nm×2+9.15×2), namely about 55 nm, will take place. Therefore, there will be a consumption of 55 nm/1.83 of nickel, namely about 30 nm. Therefore, a layer of nickel with a thickness equal to at least X=30 nm must be deposited.

The consumption in the second substrate (surface layer L2), and the amount that would have been consumed in the first substrate during the reaction with L2, are not counted so that the siliciding reaction will reach the bonding interface but will not pass through it. Therefore the thickness of the nickel layer in our example is (18.3×2)/1.83=20 nm. Consequently, the minimum thickness of the nickel layer must be more than 20 nm, in order for the alloy to be at and around the bonding interface.

According to another example, if the first substrate 1 is not made of silicon and is made of a material that does not react with the nickel layer (for example the substrate comprises a barrier layer to diffusion of nickel in the substrate), then the minimum thickness of the nickel layer must be more than 10 nm (namely 18.3/1.83), in order for the alloy to be at and around the bonding interface.

Refer to the tables published in the literature to obtain the values of ratios for other reactions.

According to one variant shown in FIGS. 3A and 3B, the second substrate 2 is also covered by a bond layer 5 made of amorphous silicon before being assembled by bonding with the assembly composed of the silicon substrate 1, the Ni layer 3 and the amorphous Si layer 4 (FIG. 3A). For example, this variant may be used when the second substrate is not compatible with the formation of the zone of alloy(s) to enable the <<crossing>> through the bonding interface. For example, we might choose to obtain an assembly structure in which the total thickness of the amorphous silicon bond layer (in other words the Si layer 4 deposited on the Ni layer 3 of the first substrate 1 and the Si layer 5 deposited on the second substrate 2) is equal to about half the thickness of the Ni layer 3 deposited on the first substrate 1. The next step is to do a heat treatment so as to make the layer of amorphous silicon 4 react with the nickel layer 3 and with the amorphous silicon layer 5. The result is then an assembly with two alloys 11 and 10 between the first substrate 1 and the second substrate 2, the two alloys in this case being silicide alloys (FIG. 3B).

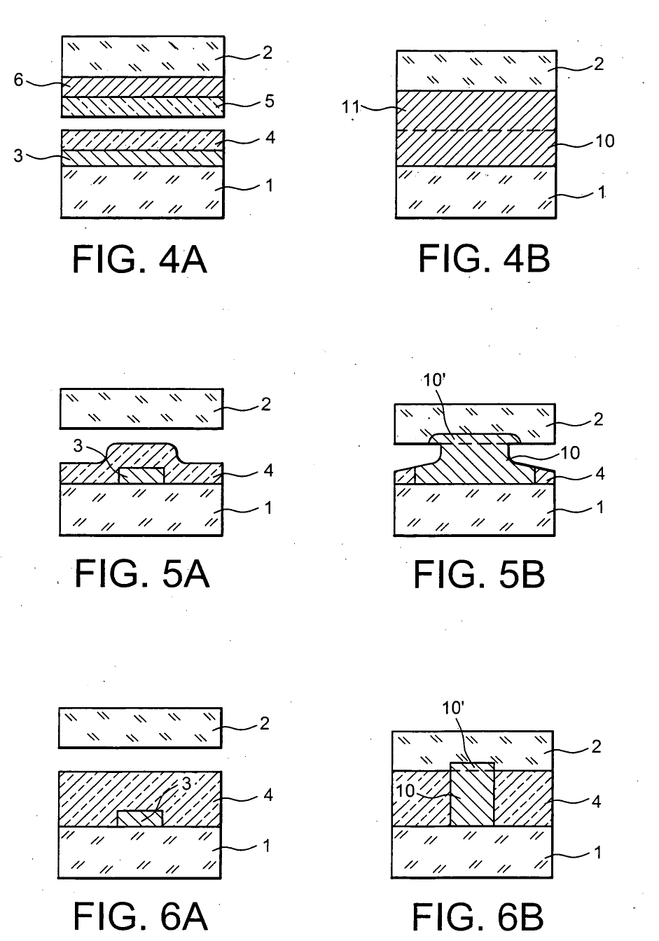

According to another variant shown in FIGS. 4A and 4B, a structure resulting from the assembly of two assemblies can be made, each of said assemblies comprising a silicon substrate 1, 2 covered by an Ni layer 3, 6 and an amorphous silicon layer 4, 5. After heat treatment, two alloys 10 and 11 of silicide are obtained (FIG. 4B).

According to another variant also shown in FIGS. 3A and 3B, a 200 nm thick layer of a nickel conducting material 3 is deposited on a substrate 1 (for example made of silicon) and this layer 3 is then covered by a bond layer 4 made of 30 nm thick amorphous silicon. This stack is assembled on a second substrate 2 (for example made of silicon) comprising a 50 nm thick germanium bond layer 5. After heat treatment of this assembly at a temperature of 400° C., for example, the result is an assembly comprising an NiSi alloy layer and an NiGe alloy layer.

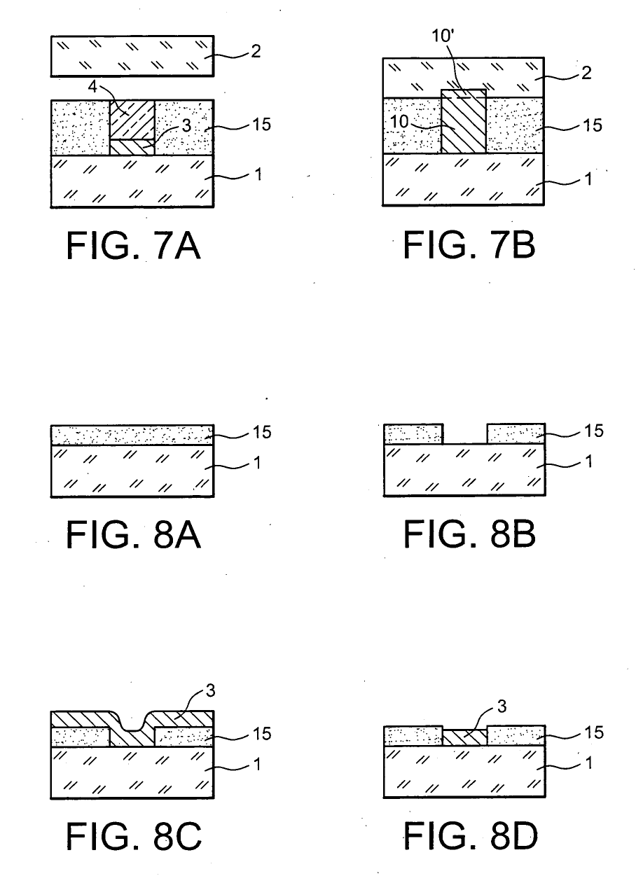

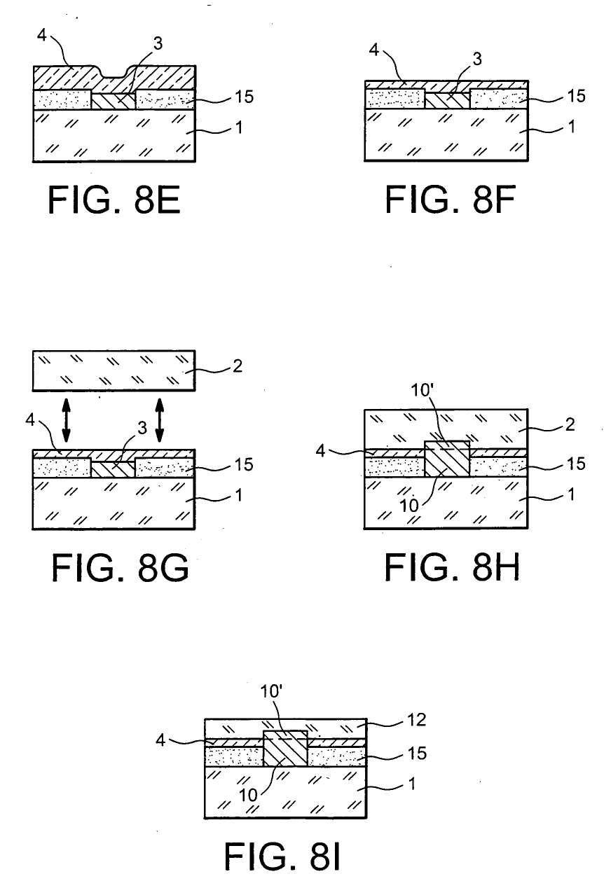

In all previously described variants, the layer of electrically conducting material 3, 6 covers the entire substrate of silicon 1, 2. According to other variants, this electrically conducting material layer may also be present only locally on the substrate 1, 2 (see FIGS. 5A and 6A). For example, this will be the case if the bonding pads of a CMOS substrate are considered. In this case, the face to be assembled may comprise a surface topography or a set of materials with different natures, some of which are insulating or incapable of reacting with the conductor M1. The insulators may be SiO₂, Si₃N₄, Al₂O₃, AlN, diamond, SiC, etc., a variant shown in FIGS. 7A and 7B (the insulating material is noted 15 in the figures). The material 15 may be initially identical to L1, and it may have been subjected to treatments making it unable to react locally with M1. One example consists of depositing an SiO₂ film 15, for example 120 nm thick, on a substrate 1 (S1), for example made of silicon (see FIG. 8A); zones, for example with a size of a few square micrometers to a few square millimetres, are <<opened>> in film 15 by lithography and etching, those methods being conventional in microelectronics (see FIG. 8B). A film 3 (M1) is then deposited, for example made of nickel, and for example 100 nm thick (FIG. 8C). A mechanical-chemical polishing process, conventional in microelectronics, eliminates nickel film zones 3 vertically in line with the unetched SiO₂ zones (FIG. 8D). The next step may then be to deposit a bond layer 4 (L1) on zones 15 of SiO₂ and zones 3 (M1), for example made of amorphous silicon with a thickness for example of 100 nm (FIG. 8E). The surface topology may be made plane using a mechanical-chemical polishing process, leaving a thickness of the layer 4 (L1) of amorphous silicon as thin as desirable, for example 20 nm, vertically in line with the SiO₂ zones 15, or possibly zero (see FIG. 8F). The polishing process used assures a surface planeness suitable for subsequent molecular bonding with a substrate 2 (S2), for example silicon, for example of a type (N or P) or a doping different from the substrate 1 (S1) (FIG. 8G). A heat treatment, for example at 400° C., is used to form the silicide phase 10, 10′ NiSi with a crossing through the bonding interface (see alloy 10′) (particularly done by limiting the thickness of the bond layer 4 (L1) after the planarisation step (FIG. 8F)) and positioning of conduction (particularly in the alloy zones 10 and 10′ surrounded by the insulating zones 15) (see FIG. 8H). Later on, one of the wafers (in this case the substrate 2) can be thinned to obtain a thin film 12 with vertical conduction zones 10, 10′ and with zones 15 insulated from the support 1 (see FIG. 8I). Thinning can then for example be done by mechanical or chemical thinning or can even be induced by induced fracture before or after the treatment to form the alloy at a buried fragile zone created in one of the two substrates (the substrate to be thinned), for example by implantation, for example by gaseous species.

According to another example, a bond layer 4 can be deposited on the local layer of electrically conducting material 3 (connection pad), to assemble the substrate 1 (of the CMOS type) with another substrate 2 (FIG. 5A). The next step is to perform heat treatment such that the electrically conducting material 3 and the bond layer 4 form an alloy 10, and an alloy 10′ originating from the reaction of the conducting material layer 3 with part of the substrate 2 that may or may not comprise a local bond layer L2 (FIG. 5B). In this variant, the alloy 10 does not occupy the entire surface of the substrates 1 and 2 as it did in the previous examples.

It is also possible to deposit a sufficient thickness of the bond layer 4 to obtain a relatively plane surface of the bond layer 4 to be assembled, for example after mechanical-chemical polishing (FIG. 6A). The location of the electrical contact between the two substrates 1, 2 at the electrically conducting local layer 3 may be obtained using the following techniques alone or in combination: etching, implantation, local heating (for example laser annealing before or after bonding, if one of the substrates is transparent). The result is then an assembly of two substrates 1, 2 through an alloy 10 in the middle of a bond layer 4 and also comprising an alloy 10′ originating from the reaction of the layer of conducting material 3 with part of the substrate 2 that may or may not comprise a local layer L2 (FIG. 6B). All the previously described variants concerning the second substrate 2 that may or may not be covered by a layer of electrically conducting material 6 and/or a bond layer 5 are equally applicable.

According to another variant, the surface of the substrates that may or may not comprise a bond layer of a determined material, is prepared by a technique making it hydrophobic. For example, to prepare the surface of a substrate comprising a bond layer of amorphous silicon, a so-called <<final HF etching>> type cleaning can be done. Dilution of hydrofluoric acid HF may for example be included in the [1%-49%] range. This acid may be used in the liquid phase or advantageously in the vapour phase to reduce the density of particles on the surface. As a variant, the surface of amorphous silicon may be made hydrophobic by a plasma treatment, for example rich in hydrogen. A heat treatment can also be carried out, for example under hydrogen at a temperature below the temperature that induces a reaction between the conducting layer and the bond layer, or if this temperature is greater than the temperature that induces the reaction between the conducting layer and the bond layer, such that the reaction generated during the treatment time does not affect the bonding surface, silicidation only being partial and buried. This can be done by varying the reaction time. The assembly composed of the substrate and the layer of amorphous Si is then bonded onto the surface of a substrate according to one of the variants described above.

According to one variant of the above examples, the silicon bond layer is made using a deposition method (for example by sputtering) that results in it having a poly-crystalline nature. In this case, the choice of the silicide to be obtained should take account of the deposition temperature of the poly-crystalline silicon: if the deposition of poly-crystalline silicon is done at a temperature of 600° C., then it is only possible to envisage silicides with a production temperature of more than 600° C., for example NiSi₂ silicide obtained at a temperature of more than 750° C. according to the literature.

Although the examples given above all have structures obtained with a metallic layer of nickel, obviously a layer made of any other electrically conducting material could be used, metals for example such as a layer of palladium, platinum, cobalt, tungsten, tantalum, titanium, vanadium, chromium, manganese, iron, molybdenum, or a mix of these elements or a conducting alloy (for example made of a silicide or germanicide of these metals). For example, a layer of an NiSi conducting alloy can be formed by bonding two substrates comprising a layer of Ni₂Si (layer of electrically conducting material) under a layer of amorphous silicon and treating the structure thus obtained at a temperature of more than 350° C.

Similarly, a bond layer made of a material other than amorphous or poly-crystalline silicon can be used. For example, a structure comprising a layer of germanicide alloy can be obtained by depositing a germanium bond layer. Similarly, with the silicides in the previous examples, the thickness of the germanium bond layer to be deposited depends on the quantity of germanicide that the user wants to form by reaction with the buried metal (in other words the layer of metallic material). The formation reaction of the alloy is controlled by the heat treatment temperature used that determines the nature of the alloy obtained, and by the heat treatment time that determines the thickness of the alloy formed as a function of the diffusion of the materials involved. For example, a layer of germanicide alloy Cu₃Ge can be formed by bonding two substrates comprising a layer of copper (metallic layer) under a germanium layer (bond layer) and treating the structure thus obtained at a temperature of more than 400° C. SiGe or SiC could also be used as a bonding material; a stack of these materials is also possible.

The process according to the invention can be used to obtain a structure in which electrical conduction can be controlled at the interface between the two assembled substrates. According to our invention, means are implemented so that the conducting alloy <<crosses>> the bonding interface between the first substrate and the second substrate. Conduction is optimised at the bonding zone using appropriate materials and thicknesses for the bond layers and electrically conducting materials are chosen that depend on various factors including the substrates to be assembled.

Advantageously, the thickness of the bond layer, the thickness of the metallic layer and the heat treatment time are adapted such that the alloy phase is induced at and around the substrate bonding interface. For example, such an approach can induce good quality purely resistive, vertical electrical conduction at and around the bonding interface.

Furthermore, in the case in which there is a metal layer in only one substrate, it is advantageous to make the metal diffuse towards the other substrate so as to induce a reaction to form a conducting alloy (for example a silicide) and thus induce good quality purely resistive vertical electrical conduction at and around the bonding interface.

Advantageously, the creation of an oxide or any other <<barrier>> layer is advantageously avoided at the faces to be assembled, which can hinder the interface being crossed by the alloy (for example by applying a preparation making the surfaces of the faces of the substrates to be assembled partly or wholly hydrophobic).

Finally, table 2 below presents a few examples of silicides formed according to the process of the invention using a layer of a determined metal X (X=Ni, Pt, Co or Pd) or a silicide (SiX) and a silicon bond layer. This table also contains the currently published values of heat treatment temperatures to be applied to obtain such or such a silicide.

TABLE 2

| | | Silicides/ | Silicides/ |
|---|---|---|---|
| | Silicides/ | formation | formation |
| Metal | Formation T (° C.) | T (° C.) | T (° C.) |
| Ni | Ni₂Si/≧200° C. | NiSi/≧350° C. | NiSi₂/≧750° C. |
| Pt | Pt₂Si/≧200° C. | PtSi/≧300° C. | |
| Co | CoSi/≧350° C. | CoSi₂/≧550° C. | |
| Pd | Pd₂Si/≧200° C. | PdSi/≧800° C. | |

In the examples described above, we have only mentioned the formation of a binary alloy. Obviously, ternary, quaternary (and more) alloys could be envisaged without going outside the framework of this invention. For example, this could be the case if a multi-metal electrically conducting layer is used.

### BIBLIOGRAPHY

[1] B. Aspar and al, “Smart-Cut process using metallic bonding: Application to transfer of Si, GaAs, InP thin films”, Electronics Letters, 10 Jun. 1999, Vol. 35, No. 12.
[2] G. Thungström and al., Physica Scripta, T 54, p 77-80, 1994.
[3] A. Shigetou, “Room Temperature Bonding of Ultra-Fine Pitch and Low-Profiled Cu Electrodes for Bump-Less interconnect”, Electronic Components and Technology Conference, 2003.
[4] Shiyang Zhu and al., “Buried cobalt silicide layer under thin silicon film fabricated by wafer bonding and hydrogen-induced delamination techniques”, Journal of the electrochemical society, Electrochemical Society Manchester, N.H., US, vol. 146, No. 7, July 1999, pages 2712-2716.

1-19. (canceled)

20: A process for assembly of a first substrate and a second substrate on contact faces by molecular bonding, the contact face of the first substrate having an electrically conducting layer on at least part of its surface, the process comprising:
depositing a bond layer on at least part of the electrically conducting layer, said bond layer being capable of achieving molecular bonding with a zone of the contact face of the second substrate and capable of combining with the electrically conducting layer to form a conducting alloy;
contacting the bond layer of the first substrate with the zone of the contact face of the second substrate and bonding them by molecular bonding,
transforming over all or part of the thickness of all or part of the electrically conducting layer with all or part of the bond layer and with at least part of the thickness of the zone of the contact face on all or part of the surface of the second substrate to form a zone of conducting alloy(s).

21: A process for assembly according to claim 20, wherein the transforming includes heat treatment.

22: A process for assembly according to claim 20, wherein the transforming includes a pressurization or an electro-migration to form an alloy.

23: A process for assembly according to claim 20, further comprising, before the contacting and bonding, forming the zone of the contact face of the second substrate by deposition of a bond layer that can achieve molecular bonding with the bond layer of the first substrate and that can react with the electrically conducting layer deposited on the first substrate to form a conducting alloy.

24: A process for assembly according to claim 23, wherein the bond layer of the first substrate and the bond layer of the second substrate are made of a same material.

25: A process for assembly according to claim 20, further comprising, before the contacting and bonding, forming the zone of the contact face of the second substrate by deposition of an electrically conducting layer covered at least partly by a bond layer capable of achieving molecular bonding with the bond layer of the first substrate and capable of combining during the transforming with said electrically conducting layer of the second substrate to form a conducting alloy.

26: A process for assembly according to claim 25, wherein the electrically conducting layer located on the zone of the contact face of the second substrate is also capable of combining, during the transforming, with the material in the bond layer located on the first substrate to form a conducting alloy included in the conducting alloy zone(s).

27: A process for assembly according to claim 25, wherein the bond layer of the first substrate and the bond layer of the second substrate are made of a same material and wherein the electrically conducting layer of the first substrate and the electrically conducting layer of the second substrate are made of a same material.

28: A process for assembly according to claim 27, wherein the electrically conducting layer located on the zone of the contact face of the second substrate is also capable of combining, during the transforming, with the material in the bond layer located on the first substrate to form a conducting alloy included in the conducting alloy zone(s).

29: A process for assembly according to claim 20, wherein the electrically conducting layer of the first substrate and/or of the second substrate is formed from a stack of one or plural films made of metal or conducting alloy.

30: A process for assembly according to claim 29, wherein the metal is chosen from among nickel Ni, platinum Pt, palladium Pd, cobalt Co, tungsten W, tantalum Ta, titanium Ti, vanadium V, chromium Cr, manganese Mn, iron Fe, molybdenum Mo or a mix of these elements.

31: A process for assembly according to claim 29, wherein the conducting alloy is chosen from among silicides or germanicides of nickel Ni, platinum Pt, palladium Pd, cobalt Co, tungsten W, tantalum Ta, titanium Ti, vanadium V, chromium Cr, manganese Mn, iron Fe or molybdenum Mo.

32: A process for assembly according to claim 20, wherein the bond layer of the first substrate and/or of the second substrate is made of a material chosen from among silicon, germanium, silicon carbide or a mix of these elements.

33: A process for assembly according to claim 20, further comprising, before the depositing the bond layer of the first and/or of the second substrate, surface treating the electrically conducting layer of the first and/or of the second substrate to remove at least part of the oxides and/or insulators present on its surface.

34: A process for assembly according to claim 20, further comprising, before the contacting and bonding of the contact faces of the two substrates, surface treating the surface of the bond layer of the first substrate and of the zone of the contact face of the second substrate.

35: A process for assembly according to claim 34, wherein said surface treating includes chemical preparation.

36: A process for assembly according to claim 34, wherein said surface treating includes a treatment leading to an entirely or partly hydrophobic surface.

37: A process for assembly according to claim 34, wherein said surface treating includes a treatment leading to an entirely or partly hydrophilic surface.

38: A process for assembly according to claim 34, wherein said surface treating includes a plasma treatment of at least one of the contact surfaces so as to obtain a high bonding energy at low temperature.

39: A process for assembly according to claim 34, wherein said surface treating includes a UV treatment and/or an ozone treatment and/or a heat treatment and/or a treatment in a controlled atmosphere.
